(19) United States
(12) Patent Application Publication
(10) Pub. No.: US 2016/0138464 A1
(43) Pub. Date: May 19, 2016

(54) ASSEMBLY FOR AN AIR CIRCUIT OF A HEAT ENGINE

(71) Applicant: VALEO SYSTEMES DE CONTROLE MOTEUR, Cergy Saint Christophe (FR)

(72) Inventors: Mathieu Lallemant, Maisons-Laffitte (FR); Sêbastien Potteau, Triel Sur Seine (FR)

(73) Assignee: Valeo Systemes de Controle Moteur, Cergy Saint Christophe (FR)

(21) Appl. No.: 14/902,858

(22) PCT Filed: Jul. 3, 2014
(86) PCT No.: PCT/FR2014/051711

§ 371 Date: Jan. 5, 2016

(30) Foreign Application Priority Data
Jul. 5, 2013 (FR) 1356603

(51) Int. Cl. F02B 37/12; F16K 11/052; F02B 39/10

(52) U.S. Cl. CPC F02B 37/127; F02B 39/10; F16K 11/0525

(57) ABSTRACT

The invention relates to an assembly (1) for an air circuit of a heat engine, which includes: a first duct (11) capable of conveying fluid; a second duct (12) extending between an inlet (13) and an outlet (14) in the first duct (11), such as to form a bypass of a portion of the first duct (11), the second duct (12) including a pressure-variation source (15); and a system for routing (10) the fluid in either the second duct (12) or said portion of the first duct (11), the routing system (10) having a first configuration allowing the fluid to flow mostly into said portion of the first duct (11), the routing system including: a holding member exerting a force configured to hold or move said routing system (10) into the first configuration; and either an area blocking all or part of the inlet of the second duct in said first configuration or an area blocking all or part of the outlet of the second duct in said first configuration, the routing system being arranged such as to enter a send configuration allowing the fluid to flow mostly into the second duct (12) when the pressure variation generated by the source (15) in the second duct (12) exceeds a predefined value, said pressure variation then exerting, on said area or areas of the routing system, a force allowing said switch to the second configuration, despite the force exerted by the holding member.

The present invention relates to an assembly for an air circuit of a heat engine.

The invention applies in particular, but not exclusively, in the motor vehicle industry, with the heat engine then making it possible to propel the vehicle.

The assembly comprises a first duct and a second duct which form a bypass of a portion of the first duct, the first and second ducts being able to have a fluid passing through them. The assembly also comprises a system for routing the fluid which makes it possible to vary the distribution of fluid between the portion of the first duct and the second duct.

It is known to provide the routing system with an actuator which makes it possible to vary the . distribution of the fluid between the portion of the first duct and the second duct. However, an actuator of this type has a cost, and requires a suitable control law.

The objective of the invention is to eliminate this disadvantage, whilst ensuring the required distribution of fluid between the portion of the first duct and the second duct.

According to one of its aspects, the invention achieves this objective by means of an assembly for an air circuit of a heat engine, comprising:
a first duct which can convey the fluid;
a second duct which extends between an input in the first duct and an output in the first duct, such as to form a bypass of a portion of the first duct, the second duct comprising a source of pressure variation; and
a system for routing of the fluid into one out of the second duct and said portion of the first duct, the routing system having a first configuration which allows the fluid to circulate mostly in said portion of the first duct, the routing system comprising:
a retention unit which exerts a force configured to bring said routing system into the first configuration or retain it there; and
at least one out of: an area which blocks in this first configuration all or part of the input of the second duct, and an area which blocks in this first configuration all or part of the output of the second duct,
   the routing system being designed to go into a second configuration which allows the fluid to circulate mostly in the second duct when the pressure variation generated in the second duct by the source exceeds a predefined value, this pressure variation then exerting on said area(s) of the routing system a force which permits this passage into the second configuration, despite the force exerted by the retention unit.

The above assembly takes advantage of the presence in the second duct of the source of pressure variation, in order to modify the configuration of the routing system. Thanks to the area(s) which, in the first configuration, block(s) at least partly the input of the second duct and/or at least partly the output of the second duct, this pressure variation can generate a force on the routing system, thus making it possible to modify the configuration of the latter.

The invention thus allows the source of pressure variation to be able to act as an actuator which gives rise to the passage of the routing system from the first configuration to the second. It is thus possible to dispense with the actuator dedicated to the routing system according to the prior art, this actuator giving rise to the passage from the first to the second configuration.

The retention unit can be selected so as to be compatible with the source of pressure variation, in order to permit the passage of the routing system into the second configuration from the predefined value of pressure variation generated by the source of pressure variation.

Independently from, or in combination with the immediately foregoing situation, the surface of the area(s) which block(s) at least partly the input and/or the output of the second duct can be selected in order to permit the passage of the routing system into the second configuration from the predefined value of pressure variation generated by the source of pressure variation.

In the first configuration of the routing system, said area can block all of the input of the second duct or all of the output of said second duct.

In this first configuration, all of the fluid can thus follow the portion of the first duct, notwithstanding leakages in the routing system.

In the second configuration of the routing system, all or part of the fluid can follow the second duct. The term “mostly” used above must be understood to mean both “more than half of the flow of the fluid in the first duct upstream from the input of the second duct” and “all of the flow of the fluid in the first duct upstream from the input of the second duct”.

In particular, the source of pressure variation is an electric compressor which is arranged in the second duct. An electric compressor of this type can make it possible to supply the heat engine with compressed air rapidly when the heat engine is running at low speed, or when there is a sudden increase of load. This compressor then assists for example a turbo charger which is associated with the heat engine, in order to eliminate the substantial response time of the turbo charger, which is also known as turbolag.

The first and the second duct can form part of the intake circuit of the heat engine.

The electric compressor can be arranged downstream from an output of an exhaust gas recirculation (EGR) loop.

The electric compressor can be arranged upstream from, downstream from, or in parallel with the compressor of the turbo charger.

According to a first example of implementation of the invention, the routing system comprises a pivoting shutter which is arranged at the input of the second duct.

According to this first example, the input and the output of the second duct can be arranged spaced from one another, in the first duct.

According to this first example, when the routing system is in the first configuration, said shutter has:
a first part which extends in the first duct, out of the input of said second duct; and
a second part which blocks all or part of the input of the second duct, and defines said area of the routing system,
   such that, when a pressure variation corresponding to low pressure at the input of the second duct, generated by the source, exceeds the predefined value, this pressure variation gives rise to pivoting of the shutter into a position in which the first part blocks all or part of said portion of the first duct, and wherein the second part extends in the second duct, whilst allowing the fluid to circulate mostly in this second duct, according to the second configuration of the routing system.

The shutter can then be aspirated towards the interior of the second duct as a result of the pressure variation, thus modifying the distribution of the fluid between the portion of the first duct and the second duct.

The section of the first part of the shutter can be smaller than the section of the second part of the shutter. A ratio of this type between these sections can assist the pivoting of the shutter in order to go from the first configuration to the second configuration when small values of pressure variation are obtained in the second duct.

In the second configuration, the shutter can block access to the portion of the first duct, such that all the fluid is directed to the source of pressure variation.

According to a second example of implementation of the invention, the routing system comprises a pivoting shutter which is arranged at the output of the second duct.

According to this second example of implementation of the invention, when the routing system is in the first configuration, the shutter has a part which blocks all or part of the output of the second duct defining said area of the routing system, such that, when a pressure variation corresponding to excess pressure at the output of the second duct, generated by the source, exceeds the predefined value, this pressure variation gives rise to pivoting of the shutter to a position in which said part blocks all or part of said portion of the first duct, according to the second configuration of the routing system.

The shutter can then be thrust out of a position opposite the output of the second duct because of the pressure variation, thus modifying the distribution of the fluid between the portion of the first duct and the second duct.

Irrespective of the configuration of the routing system, the shutter may extend only in the first duct: opposite the output of the second duct in the first configuration, and spaced from this output in the second configuration.

In the second configuration, the shutter can block the portion of the first duct, such that all the fluid is directed towards the source of pressure variation.

According to this second example of implementation of the invention, on a plane perpendicular to its pivoting shaft, the shutter may extend only on a single side of said shaft.

According to this first and second example of implementation of the invention, the routing system can thus comprise only a single shutter in order to modify the distribution of fluid in the portion of the first duct and in the second duct.

According to a third example of implementation of the invention, the routing system comprises:
a first pivoting shutter which is arranged at the input of the second duct, and in particular is identical to the shutter according to the first example of implementation of the invention; and
a second pivoting shutter which is arranged at the output of the second duct, and in particular is identical to the shutter according to the second example of implementation of the invention.

According to this third example of implementation:
when the routing system is in the first configuration, the first shutter has a first part which extends in the first duct, out of the input of said second duct, and a second part which blocks all or part of the input of the second duct, and defines one of said areas of the routing system;
when the routing system is in the first configuration, the second shutter has a part which blocks all or part of the output of the second duct, and defines another one of said areas of the routing system,
   such that, when a pressure variation corresponding to low pressure at the input of the second duct and excess pressure at the output of the second duct, generated by the source, exceeds the predefined value, according to the second configuration of the routing system this pressure variation gives rise to:
pivoting of the first shutter into a position in which the first part of the first shutter blocks all or part of said portion of the first duct, and wherein the second part of the first shutter extends in the second duct, whilst allowing the fluid to circulate mostly in this second duct; and
pivoting of the second shutter into a position in which said part of the second shutter blocks all or part of said portion of the first duct.

According to this third example of implementation of the invention, the input and the output of the second duct can be blocked completely or partly by distinct shutters when the routing system is in the first configuration, whereas two distinct shutters placed in series can block the portion of the first duct completely or partly when the routing system is in the second configuration.

According to a fourth example of implementation of the invention, the input and the output of the second duct are arranged in an adjacent manner in the first duct, and the routing system comprises a pivoting shutter which is arranged both at said input and said output.

The input and the output of the second duct can be formed by openings provided along a straight portion of the first duct.

According to this fourth example of implementation of the invention, a single shutter replaces the first and second shutters of the third example of implementation of the invention.

According to this fourth example of implementation of the invention, when the routing system is in the first configuration, said shutter has:
a second part which blocks all or part of said input and forms one of said areas of the routing system; and
a first part which blocks all or part of said output, and forms another one of said areas of the routing system,
   such that, when pressure variation corresponding to excess pressure at the output of the second duct and low pressure at the input of the second duct, generated by the source, exceeds the predefined value, this pressure variation gives rise to pivoting of the shutter into a position in which the first part blocks all or part of said portion of the first duct, and wherein the second part extends in the second duct, whilst allowing the fluid to circulate mostly in this second duct, according to the second configuration of the routing system.

The positioning of this shutter assists its pivoting, since the second part is aspirated into the second duct as a result of the low pressure at the entry of the latter, whereas the first part is thrust out of a position opposite the output of the second duct as a result of the excess pressure which exists there.

The pivoting shaft of the shutter can separate the first part of the shutter from the second part.

The ratio between the section of the first part of the shutter and the section of the second part of the shutter can be greater than one, and a ratio of this type assists the pivoting of the shutter since low pressure variation values are obtained in the second duct.

In all of the foregoing, the retention unit can be a resilient return unit. This return unit can make it possible to return the routing system from the second configuration to the first configuration, when the pressure variation generated in the second duct decreases, and in particular becomes lower than the predefined value.

The resilient return unit can comprise a spring. The source of pressure variation and at least one out of the rigidity and the unloaded position of the spring are for example selected such that the torque which is exerted on the routing system as a result of the existence of the pressure variation can adopt a value greater than the value of the torque exerted by the spring on this routing system. The routing system can then go from the first to the second configuration, with this aforementioned inequality between the torque values persisting until the routing system reaches the second configuration.

In all of the foregoing, the fluid can be a gas, such as air, exhaust gases recirculated from the exhaust of the engine, or a mixture of air and recirculated exhaust gases.

In all of the foregoing, the electric compressor can comprise a motor with variable reluctance, which for example has nominal power of between 1 and 10 kW, for example 5.5 kW, for a speed of rotation of 70,000 rpm.

The assembly is for example integrated in a motor vehicle.

The invention will be able to be better understood by reading the following description of non-limiting examples of implementation of it, and by examining the appended drawing in which:

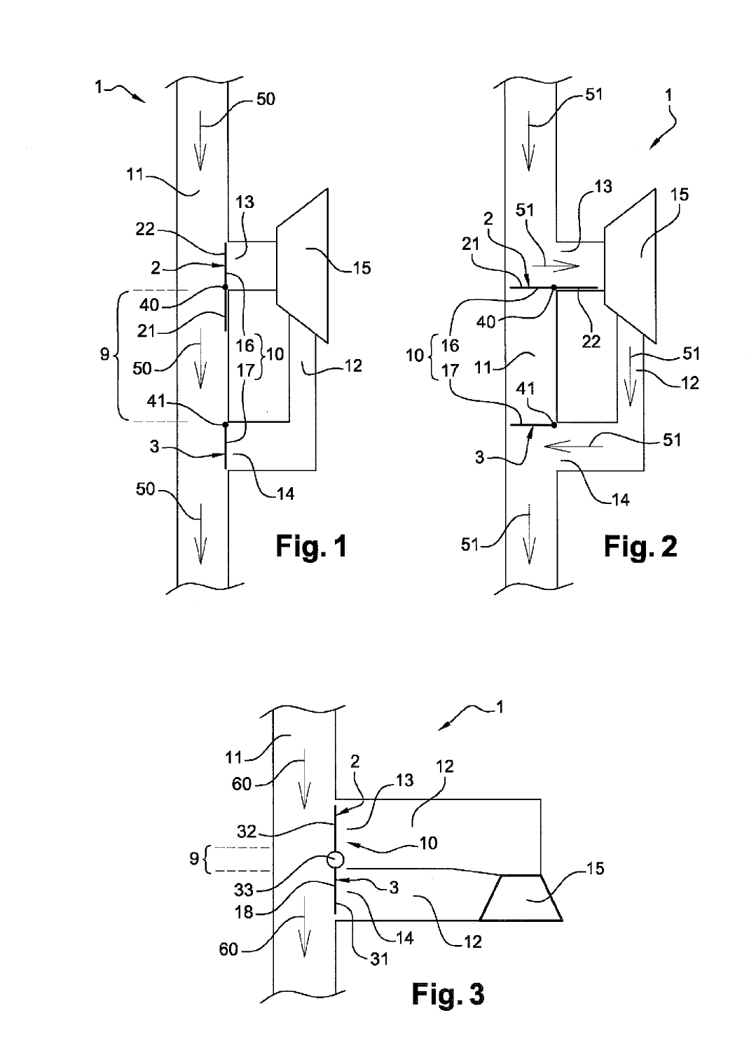

FIGS. 1 and 2 represent schematically an example of an assembly according to the invention, respectively in the first and in the second configuration of the routing system;

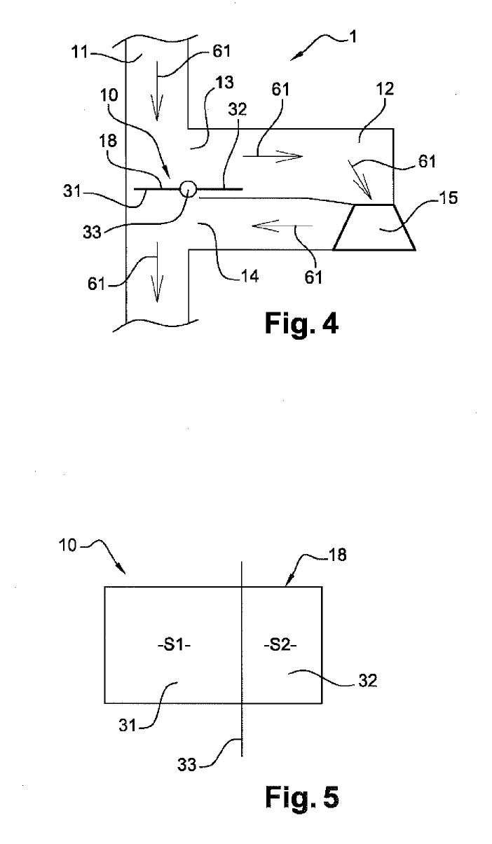

FIGS. 3 and 4 represent schematically another example of an assembly according to the invention, respectively in the first and in the second configuration of the routing system; and

FIG. 5 represents in detail the shutter of the routing system in FIGS. 3 and 4.

FIG. 1 represents an example of an assembly 1 for an air circuit of a heat engine. This is for example a heat engine of a vehicle, which runs for example on petrol or diesel. In the example, the assembly 1 forms part of the intake circuit of the heat engine. It is for example arranged downstream from the output in the intake circuit of an exhaust gas recirculation (EGR) loop.

The assembly 1 can also be associated with a mechanical compressor which forms part of a turbo charger, and is not represented in the figures.

The assembly 1 comprises:
a first duct 11 which can convey fluid;
a second duct 12 which extends between an input 13 in the first duct 11 and an output 14 in the first duct 11.

As represented in FIG. 1, the second duct thus forms a bypass of a portion 9 of the first duct 11. Reciprocally, the portion 9 of the first duct makes it possible to bypass the second duct 12.

The second duct 12 comprises an electric compressor 15 which forms a source of pressure variation. This electric compressor 15 makes it possible to assist the turbo charger in particular at low speed, or if there is a sudden increase of load. In the example concerned, this electric compressor 15 comprises a motor with variable reluctance.

In the example concerned, the first duct 11 comprises a routing system 10 which comprises:
a pivoting shutter 16 which is arranged at the input 13 of the second duct 12; and
a pivoting shutter 17 which is arranged at the output 14 of the second duct 12.

Each shutter 16, 17 is retained in, or brought into position as represented in FIG. 1 by a spring, not represented, which forms a retention unit. The spring exerts a retention force, the value of which is associated with the value of its rigidity.

When the shutters 16, 17 are in the position represented in FIG. 1, the routing system 10 is in a configuration which is known hereinafter as the “first configuration”.

In the example in FIGS. 1 and 2, the shutter 16 comprises a first part 21 and a second part 22 which are connected by a pivoting shaft 40. This pivoting shaft 40 is situated substantially at the junction between the input 13 of the second duct 12 and the first duct 11, extending opposite said input 13. In the first configuration of the routing system 10, the first part 21 extends in the first duct 11. The first part 21 extends for example parallel to the axis according to which the first duct extends at the input 13, such that the blockage of said first duct by the first part 21 is reduced when the routing system 10 is in the first configuration.

The first part 21 also extends outside the second duct 12, whereas the second part 22 forms an area 2 of the routing system 10, which in the first configuration blocks the input 13 of the second duct 12. The second part 22 extends for example in this first configuration opposite the input 13 of the second duct 12, whilst being in the first duct 11.

In the example concerned, the shutter 17 comprises a pivoting shaft 41. As can be seen in FIG. 1, when observed on a plane perpendicular to said pivoting shaft 41, the shutter 17 extends from only a single side of this shaft 41. The pivoting shaft 41 is situated substantially at the junction between the output 14 of the second duct 12 and the first duct 11, opposite this output 14.

In this example, the shutter 17 forms an area 3 of the routing system 10, which in the first configuration blocks the output 14 of the second duct 12. The shutter 17 is for example opposite said output 14, whilst extending in the first duct 11.

In the first configuration of the routing system 10, the fluid which flows in the first duct 11 upstream from the second duct 12 flows mostly in the portion 9 of the first duct 11 which avoids the second duct 12.

The path along which the fluid then passes is represented by the arrows 50. The term “mostly” used above must be understood as meaning “more than half the flow of the fluid in the first duct 11 upstream from the input 13 of the second duct 12”.

When leakage areas exist at each of the shutters 16, 17 when the routing system 1 is in the first configuration, part of the fluid can thus follow the second duct 12.

FIG. 2 represents the assembly 1 in FIG. 1 in a second configuration. In this second configuration, the first part 21 of the shutter 16 blocks the portion 9 of the first duct 11, and the second part 22 of the shutter 16 extends in the second duct 12, without blocking the latter. Again in this configuration, the shutter 17 blocks the portion 9 of the first duct 11. In this second configuration, the portion 9 of the first duct is thus doubly blocked, firstly by the shutter 16 in the vicinity of the input 13 of the second duct 12, and secondly by the shutter 17 in the vicinity of the output 14 of the second duct 12.

In this second configuration, the fluid flows mostly through the second duct 12, with the fluid passing through the first duct 11 only outside the portion 9. Thus, the fluid is bypassed on a portion of the path which it followed in FIG. 1, and then flows according to the path represented by the arrows 51.

As will now be described, the invention makes it possible to change the configuration of the routing system 10 from the first configuration described above with reference to FIG. 1, to the second configuration described above with reference to FIG. 2. The passage from the first configuration to the second is obtained without using a dedicated actuator in order to make the shutters 16 and 17 pivot, and in particular without using an electric, pneumatic or electromagnetic actuator.

The assembly 1 goes from the first configuration to the second configuration when the electric compressor 15 generates a pressure variation which exceeds a predefined value, in order to supply compressed air to the heat engine. In this example, this pressure variation corresponds to low pressure at the input 13 of the second duct 12 and to excess pressure at the output 14 of the second duct 12.

As a result of this pressure variation, force is exerted on each shutter 16, 17 by means of the areas 2, 3 of the latter which extend opposite the second duct, when the routing system is in the first configuration.

When the force exerted on each shutter 16 or 17 as a result of the excess pressure generated by the electric compressor 15 becomes greater than a predefined value, which in the example is described as being greater than the return force exerted on said shutter by the corresponding retention unit, the shutter pivots, such that the routing system 10 is in the second configuration.

The electric compressor 15 thus plays the part of an actuator which gives rise to the passage of the shutters 16 and 17 from the first configuration to the second.

When the pressure variation generated by the electric compressor 15 exerts on each shutter 16, 17 a force lower than the return force exerted by the corresponding retention unit, the shutters 16 and 17 are returned to the position of the first configuration.

FIG. 3 represents another example of an assembly 1 which differs from that which has just been described with reference to FIGS. 1 and 2 in that:
the input 13 and the output 14 of the second duct 12 are arranged in an adjacent manner in the first duct 11, such that the portion 9 has a reduced size; and
the routing system 10 comprises a single pivoting shutter 18 which is arranged both at the input 13 and the output 14 of the second duct 12.

The shutter 18 is retained in, or brought into a position such as represented in FIG. 3 by a spring, not represented, which forms the retention unit. When the shutter 18 is in the position represented in FIG. 3, the routing system 10 is in the first configuration.

In the example in FIGS. 3 to 5, the shutter 18 comprises a first part 31 and a second part 32 which are connected by a pivoting shaft 33. This pivoting shaft 33 is situated substantially at the junction between the input 13 and the output 14 of the second duct 12, opposite the input 13. FIG. 5 represents a detail of the shutter 18 in FIGS. 3 and 4. The pivoting shaft 33 separates the first part 31 from the second part 32. The ratio between the section of the first part 31 and of the second part 32 is more than one.

In the first configuration of the routing system 10, the first part 31 and the second part 32 extend in the first duct 11. These first 31 and second 32 parts extend for example parallel to the axis according to which the first duct 11 extends at the input 13 and output 14 of the second duct 12, such that the blocking of the first duct 11 by these first 31 and second 32 parts is reduced.

The first part 31 forms the area 3 of the routing system 10 which blocks the output 14 of the second duct 12, whereas, in this example, the second part 32 forms the area 2 of the routing system 10 which blocks the input 13 of the second duct 12, when the routing system 10 is in the first configuration.

In the first configuration of the routing system 10, the fluid which flows in the first duct 11 upstream from the second duct 12 flows mostly in the portion 9 of the first duct 11 which avoids the second duct 12.

The path along which the fluid then travels is represented by the arrows 60.

FIG. 4 represents the assembly 1 in FIG. 3 in a second configuration. In this second configuration, the second part 32 of the shutter 18 blocks the portion 9 of the first duct 11, and the first part 31 of the shutter 18 extends in the second duct 12, without blocking it.

In this second configuration, the fluid flows mostly through the second duct 12, with fluid passing through the first duct 11 only outside the portion 9. Thus, the fluid is bypassed along a portion of the path which it followed in FIG. 1, and then flows according to the path represented by the arrows 61.

As described with reference to FIGS. 1 and 2, the invention makes it possible to change the configuration of the routing system 10 from the first configuration described above with reference to FIG. 3, to the second configuration described above with reference to FIG. 4. The assembly 1 goes from the first configuration to the second configuration when the electric compressor 15 generates pressure variation in order to supply compressed air to the heat engine. In this example, this pressure variation corresponds to low pressure at the input 13 of the second duct 12, and to excess pressure at the output 14 of the second duct 12.

As a result of this pressure variation, force is exerted on the shutter 18 by means of the areas 2, 3 of the latter which extend opposite the second duct when the routing system is in the first configuration. As described above, this force permits passage of the routing system 10 from the first configuration to the second.

The expression “comprising a” must be understood as synonymous with the expression “comprising at least one”, except when the contrary is specified.

1. An assembly for an air circuit of a heat engine, comprising:
a first duct which conveys fluid;
a second duct which extends between an input in the first duct and an output in the first duct, such as to form a bypass of a portion of the first duct, the second duct comprising a source of pressure variation; and
a system for routing of the fluid into one out of the second duct and said portion of the first duct, the routing system having a first configuration which allows the fluid to circulate mostly in said portion of the first duct, the routing system comprising:
a retention unit which exerts a force configured to bring said routing system into the first configuration or retain it there; and
at least one out of: an area which blocks in this first configuration all or part of the input of the second duct, and an area which blocks in this first configuration all or part of the output of the second duct,
the routing system being designed to go into a second configuration which allows the fluid to circulate mostly in the second duct when the pressure variation generated in the second duct by the source exceeds a predefined value, this pressure variation then exerting on said area(s) of the routing system a force which permits this passage into the second configuration, despite the force exerted by the retention unit.

2. The assembly as claimed in claim 1, being without an actuator which gives rise to the passage of the routing system from the first configuration to the second.

3. The assembly as claimed in claim 1, comprising an electric compressor which is arranged in the second duct.

4. The assembly as claimed in claim 1, the routing system comprising a pivoting shutter which is arranged at the input of the second duct.

5. The assembly as claimed in claim 4, wherein,
when the routing system is in the first configuration, said shutter has:
a first part which extends in the first duct, out of the input of said second duct; and
a second part which blocks all or part of the input of the second duct, and defines said area of the routing system,
such that, when a pressure variation corresponding to low pressure at the input of the second duct, generated by the source, exceeds the predefined value, this pressure variation gives rise to pivoting of the shutter into a position in which the first part blocks all or part of said portion of the first duct, and wherein the second part extends in the second duct, whilst allowing the fluid to circulate mostly in this second duct, according to the second configuration of the routing system.

6. The assembly as claimed in claim 5, the section of the first part of the shutter being smaller than the section of the second part of the shutter.

7. The assembly as claimed in claim 1, the routing system comprising a pivoting shutter which is arranged at the output of the second duct.

8. The assembly as claimed in claim 7, said shutter having, when the routing system is in the first configuration, a part which blocks all or part of the output of the second duct and defines said area of the routing system, such that, when a pressure variation corresponding to excess pressure at the output of the second duct, generated by the source, exceeds the predefined value, this pressure variation gives rise to pivoting of the shutter to a position in which said part blocks all or part of said portion of the first duct, according to the second configuration of the routing system.

9. The assembly as claimed in claim 7, the shutter extending, on a plane perpendicular to its pivoting shaft, only on a single side of said shaft.

10. The assembly as claimed in claim 1, the routing system comprising:
a first pivoting shutter which is arranged at the input of the second duct; and
a second pivoting shutter which is arranged at the output of the second duct.

11. The assembly as claimed in claim 10, the first shutter having, when the routing system is in the first configuration, a first part which extends in the first duct, out of the input of said second duct, and a second part which blocks all or part of the input of the second duct, and defines one of said areas of the routing system,
when the routing system is in the first configuration, the second shutter having a part which blocks all or part of the output of the second duct, and defining another one of said areas of the routing system,
such that, when a pressure variation corresponding to low pressure at the input of the second duct and excess pressure at the output of the second duct, generated by the source, exceeds the predefined value, according to the second configuration of the routing system this pressure variation gives rise to:
pivoting of the first shutter into a position in which the first part of the first shutter blocks all or part of said portion of the first duct, and wherein the second part of the first shutter extends in the second duct, whilst allowing the fluid to circulate mostly in this second duct; and
pivoting of the second shutter into a position in which said part of the second shutter blocks all or part of said portion of the first duct.

12. The assembly as claimed in claim 1, the input and the output of the second duct being arranged in an adjacent manner in the first duct, and the routing system comprising a pivoting shutter which is arranged both at said input and said output.

13. The assembly as claimed in claim 12, said shutter having, when the routing system is in the first configuration:
a second part which blocks all or part of said input, and forms one of said areas of the routing system; and
a first part which blocks all or part of said output and forms another one of said areas of the routing system,
such that, when a pressure variation corresponding to excess pressure at the output of the second duct, and to low pressure at the input of the second duct, generated by the source, exceeds the predefined value, this pressure variation gives rise to pivoting of the shutter into a position in which the first part blocks all or part of said portion of the first duct, and wherein the second part extends in the second duct, whilst allowing the fluid to circulate mostly in this second duct, according to the second configuration of the routing system.

14. The assembly as claimed in claim 13, the pivoting shaft of the shutter separating the first part of the shutter from the second part.
